(19) United States
(12) Patent Application Publication
(10) Pub. No.: US 2020/0190775 A1
(43) Pub. Date: Jun. 18, 2020

(54) Method For Managing Operations At A Worksite

(71) Applicant: Caterpillar Inc., Peoria, IL (US)

(72) Inventors: Vishnu Gaurav SELVARAJ, Trichy (IN); Ashok Kumar KRISHNAMOORTHY, Chennai (IN); Mugesh GANESH, Chennai (IN)

(73) Assignee: Caterpillar Inc., Peoria, IL (US)

(21) Appl. No.: 16/700,397

(22) Filed: Dec. 2, 2019

(30) Foreign Application Priority Data
Dec. 12, 2018 (IN) 201811047025

(51) Int. Cl. E02F 9/26; E02F 9/20; G06Q 10/06; G01W 1/10

(52) U.S. Cl. CPC E02F 9/261; E02F 9/2054; G01W 1/10; G06Q 10/06315; G06Q 10/06312

(57) ABSTRACT

A method for managing operations at a worksite includes determining a first quantity of a material moved by one or more machines during a first period. Thereafter, the method includes receiving a first data related to a demand forecast for the material for a second period subsequent to the first period, and includes receiving a second data related to a weather forecast at the worksite for the second period. The method further includes estimating a second quantity of the material to be moved for the second period based on the first data and the second data. Furthermore, the method includes computing a change in a number of the one or more machines based on a difference between the first quantity and the second quantity for enabling movement of the second quantity of the material during the second period.

### TECHNICAL FIELD

The present disclosure relates to the management of operations at a worksite. More particularly, the present disclosure relates to methods and systems to provide a performance target and a payload target to operator or stakeholders of a fleet of one or more machines at a worksite.

### BACKGROUND

At a worksite, a fleet of machines may be employed by operators or various stakeholders to perform a set function or a common task. As an example, a fleet of machines may be applied to move materials, such as mined materials, from one part (e.g., a load location) of the worksite to another part (e.g., a dump location) of the worksite. While a quantity of the material to be mined and moved may remain largely unchanged, on several occasions, a varying demand for the material, or a changing environmental condition may cause the material to be produced (or moved) either in surplus or with shortage. When produced in surplus, the material may need to be stored as inventory, and possibly for a duration during which the material's intrinsic properties may change or deteriorate, leading to possible material wastage, increased cost, and accordingly may call for the need to have well-equipped and sufficiently large storage facilities for the material. On the other hand, a shortfall in material production may lead to a corresponding shortfall in the supply of the material (e.g., to an external customer), and thus a corresponding delay in meeting market requirements.

While the need to appropriately meet such market requirements may be a pertinent task for fleet and/or machine operators, it may also be noted that a performance of the fleet of machines generally bears a direct consequence to the overall efficiency and productivity of the operations at the worksite. For example, if one or more of the machines were consuming more time in an activity that is supposed to be performed in considerably lesser time, worksite productivity may be impacted. Similarly, factors such as excessive fueling by one or more machines, excessive cycle duration, and/or cycle time, cycle distance, and reduced material transfer (i.e., payload transfer), may limit the productivity of the one or more machines, and thus of the overall worksite.

### SUMMARY OF THE INVENTION

In one aspect, the disclosure is directed towards a method for managing operations at a worksite. The method includes determining, by a processor, a first quantity of a material moved by one or more machines during a first period. Thereafter, the method includes receiving, by the processor, a first data related to a demand forecast for the material for a second period subsequent to the first period, and includes receiving, by the processor, a second data related to a weather forecast at the worksite for the second period. The method further includes estimating, by the processor, a second quantity of the material to be moved for the second period based on the first data and the second data. Furthermore, the method includes computing, by the processor, a change in a number of the one or more machines based on a difference between the first quantity and the second quantity for enabling movement of the second quantity of the material during the second period.

In another aspect, the disclosure relates to a system including one or more machines and a server. The server includes a memory and a processor. The memory is configured to store a set of computer readable instructions. The processor is configured to execute the set of computer readable instructions to determine a first quantity of the material moved by one or more machines during a first period. Thereafter, the processor is configured to receive a first data related to a demand forecast for the material for a second period subsequent to the first period, and receive a second data related to a weather forecast at the worksite for the second period. The processor is further configured to estimate a second quantity of the material to be moved for the second period based on the first data and the second data, and, thereafter, compute a change in a number of the one or more machines based on a difference between the first quantity and the second quantity for enabling movement of the second quantity of the material during the second period.

### BRIEF DESCRIPTION OF THE DRAWINGS

FIG. 1 is a worksite and one or more machines operating at the worksite, in accordance with an embodiment of the present disclosure;

FIG. 2 is an exemplary system to manage the machines operating at the worksite, in accordance with an embodiment of the present disclosure;

FIG. 3 is an exemplary graphical layout illustrating variation of an operational parameter of one of the machines with respect to a parameter threshold range, in accordance with an embodiment of the present disclosure; and

FIG. 4 is a flowchart illustrating an exemplary method of managing the machines at the worksite, in accordance with an embodiment of the present disclosure.

### DETAILED DESCRIPTION

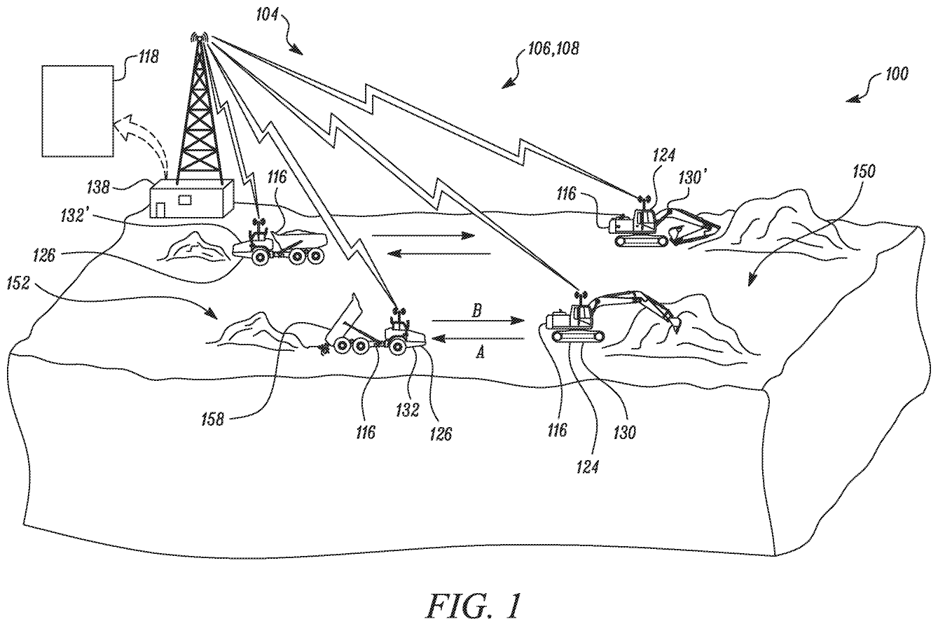

Referring to FIG. 1, a worksite 100 is illustrated. The worksite 100 may include a construction site, a mining site, etc., or may be one of a site where, for example, an open pit mining operation may be carried out. Various other operations at the worksite 100 may be contemplated. Further, such operations may be carried out by the use of a system 104, according to an aspect of the present disclosure. The system 104 may also be referred to as a worksite management system 106 or a fleet management system 108. The system 104 includes a number of machines 116 and a server 118 that is in communication with the machines 116, as depicted in FIG. 1.

The machines 116 may collaborate and operate at or between different locations of the worksite 100, so as to transfer and/or move materials, such as limestone, precious metal, copper, salt, nickel, granite, and the like, from one part of the worksite 100 to the other. The machines 116 may be of a variety of types. For example, the machines 116 may include loading machines 124, hauling machines 126, digging machines (not shown), etc. Other machine types may also be deployed at the worksite 100.

As an example, four machines 116 are illustrated. Two of the four machines 116 include loading machines 130, 130′, while the remainder two of the machines 116 include hauling machines 132, 132′. A higher or a lower number of loading machines and hauling machines may be contemplated. While it may be suggestive according to FIG. 1 that one hauling machine (e.g., hauling machine 132) is associated with one loading machine (e.g., loading machine 130), it may be noted that any number of loading machines may be associated with any number of hauling machine, in an actual site application.

Each of the machines 116 at the worksite 100 may be in communication with a central station 138, where the server 118 may be located. A depiction of a location of the server 118 within the central station 138 in FIG. 1 is exemplary, and, in some cases, the server 118, may be located elsewhere. For example, the server 118 may be located remote to the worksite 100. Further, the machines 116 may be in communication with the server 118, for example, by way of wireless communication, and, in that manner, the machines 116 may remotely transmit and receive operational data and instructions to/from the server. The loading machines 130, 130′ may be similar to each other, and, likewise, the hauling machines 132, 132′ may be also similar to each other. Under normal site and machine conditions, similar co-located loading machines 130, 130′ may perform about the same with respect to productivity and efficiency. Similarly, under normal site and machine conditions, similar co-located hauling machines 132, 132′ may perform about the same with respect to productivity and efficiency.

The loading machine 130 may be adapted to lift, carry, and load the material that, for example, may be reduced by a digging machine (not shown), onto a waiting, hauling machine 132. Examples of the loading machine 130 may include a wheeled or tracked loader, a front shovel, an excavator (as shown in FIG. 1), a cable shovel, a stack reclaimer, or any other similar machine. The loading machine 130 may operate within common areas of the worksite 100 to load the materials (e.g., reduced materials) into the hauling machine 132. For example, the loading machine 130 may be deployed generally in a stationary state at a specific location of the worksite 100, but may include moving parts, e.g., linkage assemblies and buckets, that, in its stationary state, may facilitate a drawing and dumping of the materials, into the waiting, hauling machine 132.

As an example, the location at which the loading machine 130 may be stationed may be referred to as a load location 150, while the location to which the materials may be moved or transferred (by the hauling machine 132) may be referred to as a dump location 152. Similar to the loading machine 130, the loading machine 130′ may be deployed generally in a stationary state at another specific location (i.e., another load location) (not referred to or annotated) of the worksite 100, and may include like parts that may facilitate a drawing and dumping of materials into the hauling machine 132′. Other aspects of the loading machine 130′ may remain similar to the aspects discussed for the loading machine 130.

The hauling machine 132 may be adapted to receive the materials from the loading machine 130 (i.e., from the load location 150), and carry the materials to a location where the materials may be unloaded (i.e., at the dump location 152). As an example, the worksite 100 may include roads and pathways (not explicitly shown) along which the hauling machine 132 may travel to move the material from the load location 150 to the dump location 152. After travelling to the dump location 152, and having unloaded (i.e., to dump) the materials at the dump location 152, the hauling machine 132 may return to the same location (i.e., load location 150) (or, in some cases, a different load location) along the same road (or, in some cases, along a different road). According to an aspect of the present disclosure, a travel of the hauling machine 132 from the load location 150 to the dump location 152, and then back to the load location 150 (or, in some cases, to a different load location) is referred to as one cycle of machine operation or an operational cycle of the hauling machine 132. Examples of the hauling machine 132 may include an articulated truck, an off-highway truck, an on-highway truck, or any other similar machine.

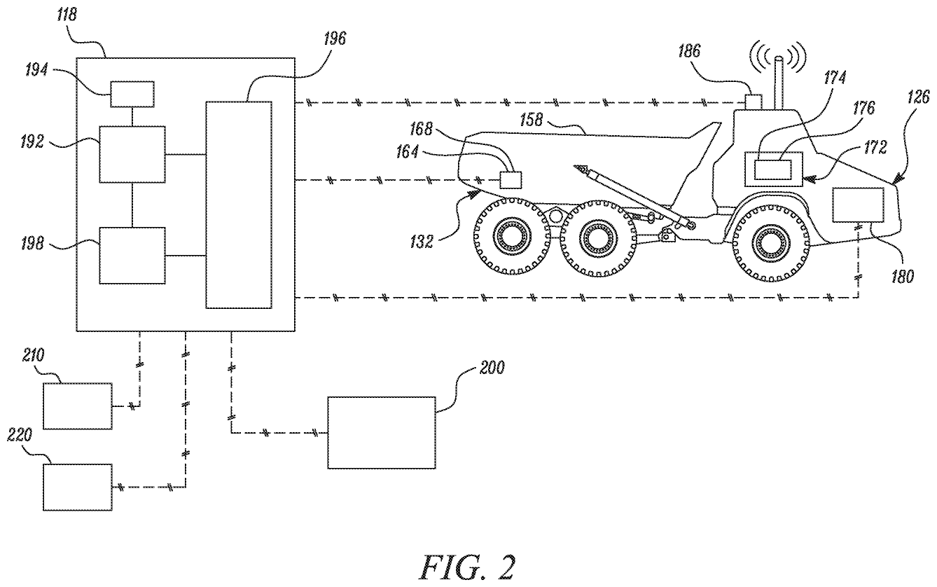

Referring to FIGS. 1 and 2, the hauling machine 132 may include a dump body 158 in which the material may be received from the loading machine 130, during a loading operation. According to some embodiments, one or more sensing devices (e.g., a sensing device 164) may be communicably coupled to the dump body 158 so as to determine a quantity of the material received into the dump body 158. For example, the sensing device 164 includes a weight sensor 168 that may be able to sense or detect a weight of the material held within the dump body 158, and thus the quantity may be determined based on the weight of the material held within the dump body 158. Further, the hauling machine 132 may also include a power system 172 having a power source 174, such as an internal combustion engine 176, and an Electronic Control Module or an ECM 180 coupled to the internal combustion engine 176. The ECM 180 may monitor various parameters of the internal combustion engine 176, such as fuel consumption. Furthermore, the hauling machine 132 may include a positioning system 186, such as a global positioning system (GPS), that may be able to determine a position of the hauling machine 132 at the worksite 100. Discussions for the hauling machine 132 may be suitably applied to the hauling machine 132′, as well. For ease, references to the hauling machine 132 may be simply referred to as ‘the machine 132’, hereinafter.

The server 118 is communicably coupled with the machine 132, such as wirelessly, and may be configured to receive, process, and store, data pertaining to various aspects related to the operations of the machine 132, and thus deduce aspects related to one (or more) operational cycle executed by the machine 132. The server 118 may be remotely located, while, in yet some examples, the server 118 may be located in situ (i.e., within and/or around the worksite 100 or relatively close to the worksite 100). In some cases, the server 118 may be a file server, and data files storing information pertaining to the operations of the machine 132 may be stored within such a file server for later retrieval and use. The server 118 may remain accessible to multiple user computers and workstations provided in and around, or remote to the worksite 100. For example, the server 118 may be accessible to one or more stakeholders (e.g., site supervisors and/or worksite operators) associated with the operations (e.g., movement of the machine 132, etc.) at the worksite 100.

Further, the server 118 may include power electronics, preprogrammed logic circuits, data processing circuits, associated input/output buses, volatile memory units, such as random-access memory (RAM) to help process data obtained from the machine. To this end, the server 118 may include a microprocessor-based device (referred to as a processor 192, hereinafter), that may be implemented as an application-specific integrated circuit, or other logic device, and such devices being known to those with ordinary skill in the art. In some implementations, the server 118 may form a portion of one of an existing database deployed within (or outside) the worksite 100, or may be configured to function as a stand-alone entity. The server 118 also includes a timer unit 194 to track time, a memory 196, and a transceiver 198.

The memory 196 is configured to store a set of computer readable instructions that are executable by the processor 192 to perform a predetermined operation (discussed later). The memory 196 may also be used to store a variety of other information. For example, the memory 196 may be configured to store data pertaining to the position, movement, and distance travelled by the machine 132, to complete each operational cycle at the worksite 100; data pertaining to a quantity of material (or a payload) transferred by the machine 132 during each operational cycle; data pertaining to a time taken by the machine 132 to complete each operational cycle; data pertaining to a distance covered by the machine 132 during each operational cycle; data pertaining to a quantity of fuel consumed by the machine 132 during each operational cycle, and the like. The memory 196 may also be configured to store data related to the specifications of the machine 132, for example, a type of machine, a load carrying capacity of the machine 132, etc. Furthermore, the memory 196 may include (i.e., to store) various tables, maps (e.g., worksite maps or terrain maps), charts, equations, and the like, either as part of the set of computer readable instructions, or otherwise as data files, for example, that may be applied to process the various aforementioned data related to the operations of the machine 132. Although not limited, it is possible for the memory 196 to include one or more of a Solid-state drive (SSD), a hard drive (HD) drive, a portable disk, USB (Universal Serial Bus) drive, memory stick, flash drives, and similar such devices known to those of skill in the art.

The transceiver 198 may enable communication between the machine 132 and the server 118, and may further enable intercommunication between the processor 192 and the memory 196. Such communication may be made possible by using one or more communication protocols, such as, I2C®, Zigbee®, Infrared, and Bluetooth®. Additionally, the transceiver 198 may be further configured to transmit and receive messages and data to/from various devices and machines operating in (or remotely to) the worksite 100 over a communication network (e.g., a satellite-based network or a local area network). For example, multiple user computers and workstations provided in and around the worksite 100 may be communicably coupled to the server 118 in accordance with the various communication protocols, such as, TCP/IP, UDP, and 2G, 3G, 4G, or 5G communication protocols.

The processor 192 may be communicably coupled to the memory 196 and to the transceiver 198, and may be configured to execute the computer readable instructions stored within the memory 196, as already noted. The processor 192 may be configured to receive data sensed by the sensing device 164 associated with determining a quantity of the material held within the machine 132 (i.e., a weight of a quantity of the material within the dump body 158 of the machine 132) at any given point. Further, the processor 192 may be configured to receive data sensed by the positioning system 186 to determine a position of the machine 132 at the worksite 100 at any given point. Additionally, the processor 192 may also be configured to receive time data as tracked by the timer unit 194. Furthermore, the processor 192 is also configured to receive data related to engine fueling as sensed or detected by the ECM 180.

Referring to FIGS. 1, 2, and 3, according to one or more aspects of the present disclosure, the processor 192 may be configured to determine one or more parameters associated with the operations of the machine 132 to move the material. This is possible by processing data received from one or more of the positioning system 186, the sensing device 164, the ECM 180, and the timer unit 194. Apart from determining data related to the aforementioned parameters, the processor 192 is also configured to detect a deviation of the parameters to an outside of a parameter threshold range (examples discussed later). The parameter threshold range may relate to a predicted Key Performance Indicator (KPI) of the machine 132. It may be noted that a deviation of the parameters to the outside of the parameter threshold range means to deviate from a set path or target intended for optimal machine operation and utilization.

In some embodiments, the processor 192 is configured to determine said deviation by retrieving and tallying data sensed by one or more of the positioning system 186, the sensing device 164, the ECM 180, and the timer unit 194, with data stored in the charts, maps, etc., within the memory 196. Based on the detection of any deviation of the parameters, the processor 192 is configured to generate a notification. The processor 192 may be configured to transmit the notification to an output device 200 that may be accessed by the stakeholders, so as to take one or more corrective actions to bring the machine 132 back to the set path or target intended for optimal machine operation and utilization. As an example, the output device 200 may include hand-held devices, such as smartphones, tablets, etc., or alternatively, may include workstations, computers, that may be in ready access to the stakeholders, and onto which the notification may be transmitted by the processor 192 by conventional communication methods, such as by emails, short messaging services (SMS), etc.

Alternatively, such data may be transmitted to other computing and storage devices, as well. Discussions related to some exemplary parameters, according to one or more aspects of the present disclosure, and associated processing of those parameters by the processor 192, will now follow.

According to one embodiment, the parameter includes a distance travelled by the machine 132 to complete one (or more) operational cycle at the worksite 100. In this regard, the processor 192 may be configured to retrieve data pertaining to the position of the machine 132 at the worksite 100 by using data from the positioning system 186. More particularly, the processor 192 may instruct the positioning system 186 to detect a position of the machine 132 in an uninterrupted fashion (or at certain intervals), and may further command the positioning system 186 to feed and store data related to the position of the machine 132 into the memory 196 with a related timestamp (e.g., by use of the timer unit 194). By accessing the memory 196, therefore, a data related to the position of the machine 132, for the one (or more) operational cycle (or for any arbitrary period), for any given time, may be accessed and determined. By analyzing data related to the position of the machine 132 for the one (or more) operational cycle, the processor 192 may further determine a data related to a movement of the machine 132 for the one (or more) operational cycle. Exemplary discussions related to a deduction of the one (or more) operational cycle of the machine 132 will now follow.

As an example, the processor 192 may be pre-fed with the data related to the load location 150 and the dump location 152, and, as and when the positioning system 186 may indicate a variation (e.g., an incremental variation) of the position of the machine 132 towards the dump location 152 from the load location 150 (e.g., along a predefined path), the processor 192 may determine that an operational cycle has begun. Optionally, the processor 192 determines the beginning of the operational cycle only after detecting that a minimum quantity of material has been loaded into the dump body 158, and for which, the processor 192 may use data from the sensing device 164. Further, the processor 192 may determine the point (and time) from which the machine 132 starts moving away from the load location 150 as the start point of the operational cycle. As the machine 132 further progresses (or travels) towards the dump location 152, a position of the machine 132 may be tracked by the positioning system 186, and the same may be fed to the processor 192. Once the machine 132 reaches the dump location 152, the processor 192 tallies the data received from the positioning system 186 with the pre-fed data related to the dump location 152. At this stage, as data received from the positioning system 186 may match with the pre-fed data related to the dump location 152, the processor 192 may determine that the machine 132 is at the dump location 152.

The processor 192 may track a further movement of the machine 132 in a similar fashion, as the machine 132 returns from the dump location 152 to the load location 150. Once the machine 132 returns to the load location 150, for example, the processor 192 may again match data, sought from the positioning system 186, with the pre-fed data related to the load location 150. Since, at this stage, the data from the positioning system 186 may match with the pre-fed data related to the load location 150, the processor 192 determines that the machine 132 has returned to the load location 150. Further, at this point, the processor 192 may determine the point (and time) at which the machine 132 returns to the load location 150 as the end point of the operational cycle. In brevity, an operational cycle means a start of the machine 132 from the load location 150, a travel to the dump location 152, and further, a return to the load location 150 (see arrows, A and B) (FIG. 2), as has also been succinctly discussed above.

Since the processor 192 may receive data from the positioning system 186 in an uninterrupted fashion (or at certain intervals), data related to the various positions of the machine 132 in between the start point (i.e., load location 150) and the end point (i.e., return to the load location 150 from the dump location 152) may be determined. Further, a path traversed by the machine 132 at the worksite 100 for the one (or more) operational cycle may also be determined based on the various positions of the machine 132 in between the start point and the end point. Such a path may be generated (e.g., extrapolated virtually) by the processor 192 according to some embodiments of the present disclosure. Given such determination of the path (which may include bends, turns, curves, etc.) by the processor 192, the processor 192 may also be configured to determine a distance (e.g., virtual distance) between the start point and the end point of the one (or more) operational cycle, and may further be configured to co-relate said virtual distance with the terrain map stored within the memory 196, to compute the distance covered by the machine 132 to complete the one (or more) operational cycle at the worksite 100. Said distance may also be referred to as cycle distance, hereinafter.

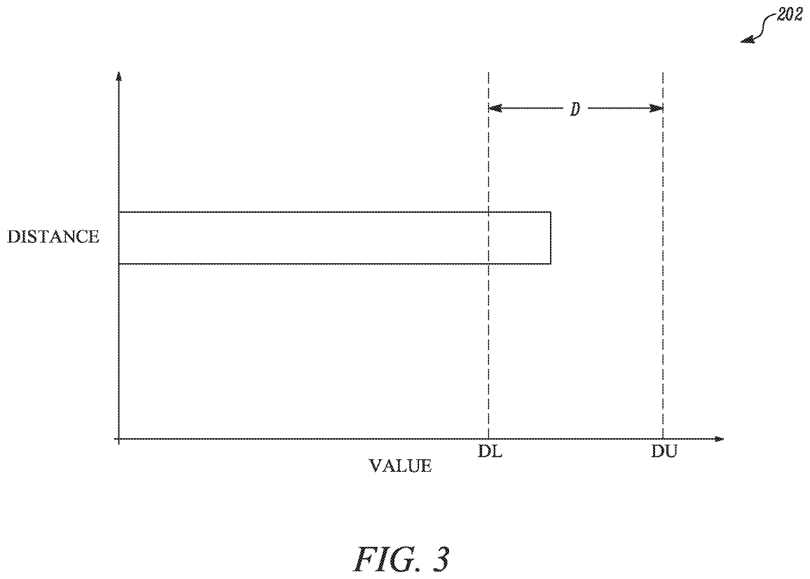

Further, the processor 192 may also be able to gather old, historical data related to a least distance traversed or taken by the machine 132 from the start point to the end point (i.e., to complete a similar one (or more) operational cycle at the worksite 100) from the memory 196 (or from a virtual memory that may be linked with the memory 196). Based on the least distance, the processor 192 may determine the parameter threshold range as a distance threshold range, D (see FIG. 3).

With reference to FIG. 3, the graphical layout 202 exemplarily includes ‘distance’ as the parameter on the Y-axis and ‘value’ denoting the distance in units on the X-axis. The distance threshold range, D, may be defined (along the X-axis) by an upper limit ‘DU’ and a lower limit ‘DL’. When the distance traversed by the machine 132 remains within the upper limit ‘DU’ and the lower limit ‘DL’ (i.e., if the distance traversed by the machine 132 is within the distance threshold range, D), the processor 192 may deem the distance traversed by the machine 132 to be an ‘optimum distance’. However, if the distance traversed by the machine 132 is above the upper limit ‘DU’ or below the lower limit ‘DL’ (i.e., if the distance traversed by the machine 132 is outside the distance threshold range, D), the processor 192 may deem the distance traversed by the machine 132 to be a ‘non-optimum distance’. In an embodiment, the upper limit ‘DU’ and the lower limit ‘DL’ is determined as a percentage of the least distance.

According to some embodiments, the parameter includes the quantity of fuel consumed by the machine 132 during one (or more) operational cycle at the worksite 100 (or, in some cases, during any arbitrary work period, different from the one (or more) operational cycle, at the worksite 100). In this regard, the processor 192 may be configured to retrieve data pertaining to a quantity of fuel consumed by the machine 132 by using data from the ECM 180. More particularly, the processor 192 may instruct the ECM 180 to detect the quantity of fuel consumed in an uninterrupted fashion (or at certain intervals), and may further command the ECM 180 to feed and store data related to the quantity of fuel consumed in the memory 196 with a related timestamp (e.g., by use of the timer unit 194). By accessing the memory 196, therefore, a data related to the quantity of fuel consumed may be accessed and determined. Since the processor 192 may be able to compute the start point and the end point of the one (or more) operational cycle, the processor 192, based on the data related to the quantity of fuel detected by the ECM 180, may also be able to determine the quantity of fuel consumed by the machine 132 during the one (or more) operational cycle (i.e., from the start point to the end point). In some embodiments, as the processor 192 may determine the quantity of fuel consumed by the machine 132, the processor 192 may also be able to compute a fuel efficiency of the machine 132 by using the data related to the quantity of fuel and the data related to the cycle distance.

Further, the processor 192 may also be able to gather old, historical data related to a least quantity of fuel consumed by the machine 132 to complete a similar one (or more) operational cycle at the worksite 100 (i.e., from the start point to the end point) from the memory 196 (or from a virtual memory that may be linked with the memory 196). Based on the least quantity of fuel consumed, the processor 192 may determine the parameter threshold range as a fuel consumption threshold range. Similar to the discussions related to the graphical layout 202 above, a graphical layout related to the quantity of fuel consumed may be contemplated. Such a graphical layout may include ‘quantity of fuel consumed’ as the parameter on the Y-axis and ‘value’ denoting the units of the quantity of fuel consumed on the X-axis. The fuel consumption threshold range may correspondingly define an upper limit and a lower limit of the quantity of fuel (similar to the upper limit ‘DU’ and the lower limit ‘DL’) that may be consumed by the machine 132. When the quantity of fuel consumed remains within the upper limit and the lower limit (i.e., if the quantity of fuel consumed is within the fuel consumption threshold range), the processor 192 may deem the quantity of fuel consumed to be of an ‘optimum quantity’. However, if the quantity of fuel consumed is above the upper limit or below the lower limit (i.e., if the quantity of fuel consumed is outside the fuel consumption threshold range), the processor 192 may deem the quantity of fuel consumed to be of a ‘non-optimum quantity’. In an embodiment, the upper limit and the lower limit is determined as a percentage of the least quantity of fuel consumed.

According to some embodiments, the parameter includes the time or duration taken by the machine 132 to complete one (or more) operational cycle (or, in some cases, any arbitrary work period, different from the one (or more) operational cycle, at the worksite 100). In this regard, the processor 192 may be configured to retrieve data pertaining to a duration taken by the machine 132 by using data from the timer unit 194. More particularly, the processor 192 may instruct the timer unit 194 to detect the time in an uninterrupted fashion (or at certain intervals), and may further command the timer unit 194 to feed and store data related to time in the memory 196. By accessing the memory 196, therefore, a data related to time may be accessed and determined. Since the processor 192 may be able to compute the start point and the end point of the one (or more) operational cycle, the processor 192, based on the data (related to time) detected by the timer unit 194, may also be able to determine the duration taken by the machine 132 to complete the one (or more) operational cycle at the worksite 100 (i.e., from the start point to the end point).

Further, the processor 192 may also be able to gather old, historical data related to a least duration taken by the machine 132 to complete a similar one (or more) operational cycle at the worksite 100 (i.e., from the start point to the end point) from the memory 196 (or from any virtual memory that may be linked with the memory 196). Based on the least duration, the processor 192 may determine the parameter threshold range as a duration threshold range. Similar to the discussions related to the graphical layout 202 above, a graphical layout related to the duration may be contemplated. Such a graphical layout may include ‘duration’ as the parameter on the Y-axis and ‘value’ denoting the units of duration on the X-axis. The duration threshold range may correspondingly define an upper limit and a lower limit of the duration (similar to the upper limit ‘DU’ and the lower limit ‘DL’) that may be taken by the machine 132, where when the duration taken by the machine 132 remains within the upper limit and the lower limit (i.e., if the duration is within the duration threshold range), the processor 192 may deem the duration taken to be an ‘optimum duration’. However, if the duration taken by the machine 132 is above the upper limit or below the lower limit (i.e., if the duration is outside the duration threshold range), the processor 192 may deem the duration taken to be a ‘non-optimum duration’. In an embodiment, the upper limit and the lower limit is determined as a percentage of the least duration.

According to some embodiments, the parameter includes the payload (e.g., weight of a quantity of material) transferred by the machine 132 during the one (or more) operational cycle. In this regard, the processor 192 may be configured to retrieve data pertaining to the payload transferred by the machine 132 by using data from the sensing device 164. More particularly, the processor 192 may instruct the sensing device 164 to detect the payload in an uninterrupted fashion (or at certain intervals), and may further command the sensing device 164 to feed and store data related to the payload in the memory 196. By accessing the memory 196, therefore, a data related to payload may be accessed and determined. Since the processor 192 may be able to compute the start point and the end point of the one (or more) operational cycle, the processor 192, based on the data (related to the payload) detected by the sensing device 164, may also be able to determine the payload transferred by the machine 132 during the one (or more) operational cycle at the worksite 100 (i.e., from the start point to the end point).

Further, the processor 192 may also be able to gather old, historical data related to a maximum quantity of payload transferred (or transferrable) by the machine 132 during a similar one (or more) operational cycle at the worksite 100 (i.e., from the start point to the end point) from the memory 196 (or from any virtual memory that may be linked with the memory 196). Based on the maximum quantity of payload, the processor 192 may determine the parameter threshold range as a payload threshold range. Similar to the discussions related to the graphical layout 202 above, a graphical layout related to the payload may be contemplated. Such a graphical layout may include ‘payload’ as the parameter on the Y-axis and ‘value’ denoting the units of the payload on the X-axis. The payload threshold range may correspondingly define an upper limit and a lower limit of the payload (similar to the upper limit ‘DU’ and the lower limit ‘DL’) that may be transferred by the machine 132, where when the payload remains within the upper limit and the lower limit (i.e., if the payload is within the payload threshold range), the processor 192 may deem the payload transferred by the machine 132 to be an ‘optimum payload’. However, if the payload is above the upper limit or below the lower limit (i.e., if the payload is outside the payload threshold range), the processor 192 may deem the payload transferred by the machine 132 to be a ‘non-optimum payload’. In an embodiment, the upper limit and the lower limit is determined as a percentage of the maximum quantity of payload.

Referring to FIGS. 1, 2, 3, and 4, based on any one or more of the aforementioned parameters falling outside their respective parameter threshold ranges (i.e., based on a deviation of any one or more of the parameters), as the processor 192 may generate corresponding one or more notifications, and as the stakeholders may take one or more corrective actions to meet performance targets to bring the machine 132 back to the set path or target intended for optimal machine operation and utilization, the processor 192 is also configured to detect a return of the one or more parameters into the corresponding parameter threshold range pursuant to the generation of the one or more notifications. Upon detection of such a return, the processor 192 may be configured to generate an additional notification that may be used by the processor to help perform one or more additional functions, as part of the exemplary method, for managing operations at the worksite, as will be understood from the description further below. The method has been discussed by way of a flowchart 400.

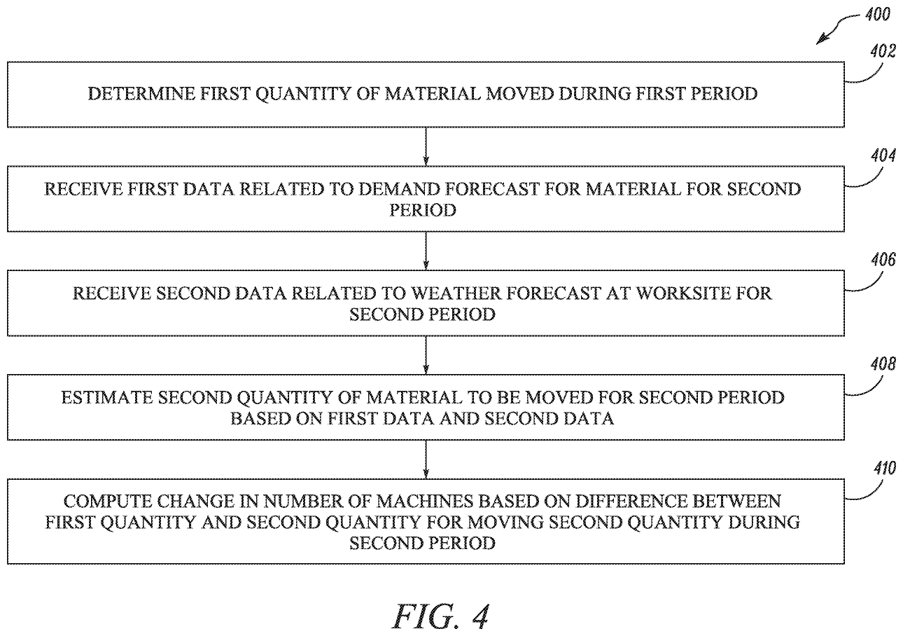

Referring to FIG. 4, in addition to the performance targets, the processor 192 is also configured to provide payload targets to the stakeholders for an upcoming period(s) at the worksite 100. According to one aspect of the present disclosure, payload targets mean the amount or quantity of material that needs to be moved for the upcoming period(s). To this end, (and exemplarily based on the additional notification or the return of the one or more parameters into the parameter threshold range, for example) the processor 192 is configured to determine a first quantity of a material moved by the machine 132 during a first period of machine operation at the worksite 100 (Block 402). The first period may relate to a relatively small period of machine operation at the worksite 100, such as equaling up to a single operational cycle. Alternatively, the first period may relate to relatively larger periods, such as equaling up to multiple operational cycles, amounting to a week, a month, a year, and the like. Further, the first period may relate to a historical period for which data pertaining to the payload produced, payload moved, number (and type) of machines used, load carrying capacity of machine, etc., may be determined and stored within the memory 196.

Further, the processor 192 is configured to receive a first data related to a demand forecast for the material for a second period subsequent to the first period (Block 404). As noted for the first period, the second period may relate to a small period of machine operation at the worksite 100, such as for a single operational cycle, and, for example, the first period may be equal to the second period. In some cases, however, the second period may differ from (or be unequal to) the first period—for example, the first period may be a first month, while the second period may be one or more months occurring in succession or sequence to the first month. As with the first period, the second period may also relate to relatively larger periods, such as multiple operational cycles, amounting to a week, a month, a year, and the like.

Further, the demand forecast for the material may include at least one of a stock value or a commodity rate associated with the material. As an example, the demand forecast may be retrieved from a market-linked database 210. A higher stock value associated with the material or a higher commodity rate of the material may mean an increase in the demand forecast for the material. Further, in some embodiments, the demand forecast may be inferred from a number of units of the material sold or which have been purchased—higher the units sold/purchased may mean a commensurately higher demand for the material. A demand forecast may also relate to a purchase price or a selling price of the material—where, for example, an increase in the selling price or the purchase price may mean an increase in the demand for the material. A variety of other factors may also determine a demand forecast for the material. For example, an overhaul and enhancement in logistics and delivery of the materials may mean an increase in the demand for the material, and the same may be applied in determining the first data by the processor 192.

The processor 192 is also configured to receive a second data related to a weather forecast at the worksite 100 for the second period (Block 406). As an example, the weather forecast may be retrieved from a weather-linked database 220. According to some exemplary embodiments, a weather forecast may include multiple weather-based factors. For example, the weather forecast may include data related to the humidity, cloudiness, haze, pollution, wind speeds, temperature, etc., at the worksite 100, for the second period. In one example, a clear weather condition (e.g., an air quality index is below a predefined air quality value) may mean (i.e., to be inferred by the processor 192) that an increased productivity at the worksite 100 is possible, and, accordingly, a weather forecast may indicate a favorable condition for higher production and movement of the material at the worksite 100 for the second period. On some occasions, a weather forecast may also mean less than favorable conditions for the production and transfer of the materials. For example, a rainy weather condition (e.g., a precipitation index is above a predefined precipitation threshold) may mean (i.e., to be inferred by the processor 192) that the machine 132 (or all machines 116) may be able to operate or move only limitedly over the worksite 100, possibly resulting in reduced production and transfer of materials.

According to some embodiments of the present disclosure, the processor 192 is further configured to estimate a second quantity of the material to be moved for the second period based on the first data and the second data (Block 408). It will be appreciated that the second quantity is the target payload or a forecasted payload for the second period that may be transmitted by one or more of the aforementioned communication methods, such as emails, short messaging services (SMS), etc., to the stakeholders via the output device 200. In that manner, the stakeholders may take requisite action at the worksite 100 to meet the demand related to the second quantity.

According to some examples, an increased material demand for the second period by way of the first data and a favorable weather condition at the worksite 100 for the second period by way of the second data may correspond to an increased payload target (and an increased second quantity) for the second period, in relation to the payload (i.e., first quantity) moved for the first period. According to another example, a reduced material demand for the second period by way of the first data and a less than favorable weather condition at the worksite 100 for the second period by way of the second data may correspond to a decreased payload target (and a decreased second quantity) for the second period, in relation to the payload (i.e., first quantity) moved for the first period.

In yet another example, if the humidity is relatively less (e.g., less than 50%), wind speeds are relatively low (e.g., less than 10 kilometers per hour), and the temperature is relatively moderate (e.g., 20° Celsius-30° Celsius), then the processor 192 may determine a favorable weather condition at the worksite 100 for the second period by way of the second data. However, if the first data related to the demand forecast is less, then the processor 192 may compute if any (relatively near) period (such as a third period occurring immediately in succession to the second period) has a similar, higher, or a lower demand for the material. If any (relatively near) period subsequent to the second period has a higher payload target or higher forecasted payload, the processor 192 may still estimate a higher second quantity to be produced and moved for the second period, even though the first data related to the demand forecast is less. Similar such examples may be contemplated.

Furthermore, the processor 192 is configured to simulate and/or compute a change in a number of the hauling machines 126 based on a difference between the first quantity and the second quantity for enabling movement of the second quantity of the material during the second period (Block 410). This is because a higher second quantity relative to the first quantity would mean a proportionally higher number of hauling machines 126 to move the higher second quantity. Similarly, a lesser second quantity relative to the first quantity would mean a proportionally lesser number of hauling machines 126 to move the lesser second quantity.

Further, the change in the number of the machines (e.g., hauling machines 126) may be computed since the load carrying capacity of each machine (e.g., hauling machines 126) (existing and any newly hired) may be known. For example, a machine (or a number of machines) with a (cumulative) load carrying capacity of ‘N tons’ should be able to move material weighing ‘N tons’. If it were required to move materials weighing less than ‘N tons’, a machine (or a number of machines) with a (cumulative) load carrying capacity of less than ‘N tons’ may be applied. Although the change in the number of the machines has been discussed generally in relation with the hauling machines 126, it may be noted that a similar change in the number of machines may be applicable to the loading machines 124, as well.

According to an embodiment, computing the change in the number of the machines (e.g., hauling machines 126) includes that the processor 192 estimate both—an increase in the number of the machines if the second quantity is higher than the first quantity by a first value; and a decrease in the number of the machines (e.g., hauling machines 126) if the second quantity is lesser than the first quantity by a second value. Both the first value and the second value may correspond to a (relatively small) percentage of the first quantity. For example, the first value may correspond anywhere up to 5% of the first quantity (e.g., weight of the first quantity), while the second value may similarly correspond anywhere up to 5% of the first quantity (e.g., weight of the first quantity). It may be noted, however, that the first value and the second value may change and may instead depend upon the total load carrying capacity of all machines or the total payload moved during the first period.

In an embodiment, pursuant to the computation of the difference between the first quantity and the second quantity, the processor 192 may further simulate and/or estimate the change in the quantity of fuel, payload per operational cycle, operational cycle count per machine, etc., vis-a-vis the change in the number of the machines 116.

### INDUSTRIAL APPLICABILITY

During operation, the processor 192 may compare a parameter of the machine 132 (or of all machines 116) with the parameter threshold range (i.e., a Key Performance Indicator) of the machine 132. If the parameter is the fuel consumed by the machine 132, and if it is determined by the processor 192 that the quantity of fuel consumed by the machines 116 is outside the fuel consumption threshold range, the stakeholders may receive a corresponding notification (e.g., via the output device 200) relating to the over fueling of the machines 116. Pursuant to the receipt of such a notification, the stakeholders may compare the fueling of all machines 116 and may determine that one or more of the machines 116 (or a certain number or a category of machines 116) are consuming needlessly extra fuel. Once the one or more of the machines 116 are identified, the stakeholder may receive an actionable insight to check whether the needlessly extra fuel consumption is because of one or more of operator faults, machine faults, procedural faults, and the like. A similar procedure may be understood and followed for each of the other parameters discussed above, so as to check whether the machines 116 are in any way underperforming.

Based on the actionable insight, the stakeholders may check, rectify, and bring the machine 132 (or one or more of the machines 116) back to the set path or target intended for optimal machine operation and utilization. In so doing, the quantity of fuel consumed by the machines 116 may return to be within the fuel consumption threshold range. The processor 192 may generate an additional notification based on the return. Based on the additional notification, or otherwise, the processor 192 may configured to execute the set of computer readable instructions, stored within the memory 196, to determine a first quantity of the material moved by machines 116 during a first period; receive a first data related to a demand forecast for the material for a second period subsequent to the first period; receive a second data related to a weather forecast at the worksite 100 for the second period; estimate a second quantity of the material to be moved for the second period based on the first data and the second data; and compute a change in a number of the machines 116 based on a difference between the first quantity and the second quantity for enabling movement of the second quantity of the material during the second period, as have been discussed by way of the flowchart 400 above.

As an example, if the processor 192 determines by seeking input from the market-linked database 210 that the commodity prices of the material being moved by the machines 116 have increased, the processor 192 may generate a notification indicating the increased demand (i.e., second quantity) for material. In such a case, the stakeholders may wish to scale up their production of the material, and based on which the processor 192 (as desired or instructed by the stakeholders) may also further compute a change in a number of the machines 116 based on a difference between the first quantity and the second quantity. As a result, the stakeholder may obtain (e.g., via the output device 200) actionable insights related to the payload target or forecasted payload to be moved for any subsequent period (e.g., the second period).

With regard to an example related to the simulation and computation of the change in the number of machines 116, if for the first period, 20 machines (i.e., 20 of the machines 116) were required to produce and move 10000 tons of the material for a first month, and if the forecasted payload to be moved for a second month subsequent to the first month is estimated by the processor 192 to be 15000 tons, the processor 192 may compute that with current production capacity of the 20 machines, a time required to produce and move the material may take up to 45 days (i.e., more than a month). According to stakeholder requirements, the processor 192 may further help compute that the number of machines (e.g., machines 116) required to produce and move 15000 tons for the second month is 23, exemplarily.

In that manner, the processor 192, and the server 118, as a whole, helps the stakeholders decide whether to rent, hire, or purchase, new machines to meet the increased demand and forecasted payload (of 15000 tons in the above example) so that the target payload or forecasted payload may be moved within the second period. With the target payload or the forecasted payload moved, the stakeholders are at an advantage to efficiently meet future market requirements. Moreover, the processor 192, and the server 118, as a whole, also helps the stakeholders identify actionable insights related to performance targets of the machines 116, thus helping the machines 116 remain optimized and productive.

It will be apparent to those skilled in the art that various modifications and variations can be made to the system of the present disclosure without departing from the scope of the disclosure. Other embodiments will be apparent to those skilled in the art from consideration of the specification and practice of the system disclosed herein. It is intended that the specification and examples be considered as exemplary only, with a true scope of the disclosure being indicated by the following claims and their equivalent.

What is claimed is:

1. A method for managing operations at a worksite, the method comprising:
determining, by a processor, a first quantity of a material moved by one or more machines during a first period;
receiving, by the processor, a first data related to a demand forecast for the material for a second period subsequent to the first period;
receiving, by the processor, a second data related to a weather forecast at the worksite for the second period;
estimating, by the processor, a second quantity of the material to be moved for the second period based on the first data and the second data; and
computing, by the processor, a change in a number of the one or more machines based on a difference between the first quantity and the second quantity for enabling movement of the second quantity of the material during the second period.

2. The method as claimed in claim 1 including
detecting, by one or more sensing devices, a weight of the material moved during the first period, wherein the first quantity is determined based on the weight of the material.

3. The method as claimed in claim 1, wherein the first data includes at least one of a stock value or a commodity rate associated with the material being moved by the one or more machines.

4. The method as claimed in claim 1, wherein computing the change in the number of the one or more machines includes:
estimating, by the processor, an increase in the number of the one or more machines if the second quantity is higher than the first quantity by a first value; and
estimating, by the processor, a decrease in the number of the one or more machines if the second quantity is lesser than the first quantity by a second value.

5. The method as claimed in claim 1, further including:
determining, by the processor, one or more parameters associated with an operation of the one or more machines for moving the material;
detecting, by the processor, a deviation of the one or more parameters to an outside of a parameter threshold range; and
generating, by the processor, a notification based on the deviation.

6. The method as claimed in claim 5, wherein
detecting, by the processor, a return of the one or more parameters into the parameter threshold range pursuant to the generation of the notification, wherein
the first quantity of the material is determined upon the return of the one or more parameters into the parameter threshold range.

7. The method as claimed in claim 5, wherein the one or more parameters include a quantity of fuel consumed by the one or more machines during one operational cycle at the worksite, and the parameter threshold range includes a fuel consumption threshold range determined based on a least quantity of fuel consumed by the one or more machines during a similar operational cycle at the worksite.

8. The method as claimed in claim 5, wherein the one or more parameters include a duration taken by the one or more machines to complete one operational cycle at the worksite, and the parameter threshold range includes a duration threshold range determined based on a least duration taken by the one or more machines to complete a similar operational cycle at the worksite.

9. The method as claimed in claim 5, wherein the one or more parameters include a distance travelled by the one or more machines to complete one operational cycle at the worksite, and the parameter threshold range includes a distance threshold range determined based on a least distance taken by the one or more machines to complete a similar operational cycle at the worksite.

10. The method as claimed in claim 5, wherein the one or more parameters include a payload transferred by the one or more machines during one operational cycle at the worksite, and the parameter threshold range includes a payload threshold range determined based on a maximum quantity of payload transferrable by the one or more machines for a similar operational cycle at the worksite.

11. A system, comprising:
one or more machines configured to move a material from a load location to a dump location at a worksite; and
a server communicably coupled to the one or more machines, the server including:
a memory configured to store a set of computer readable instructions; and
a processor configured to execute the set of computer readable instructions to:
determine a first quantity of the material moved by the one or more machines during a first period;
receive a first data related to a demand forecast for the material for a second period subsequent to the first period;
receive a second data related to a weather forecast at the worksite for the second period;
estimate a second quantity of the material to be moved for the second period based on the first data and the second data; and
compute a change in a number of the one or more machines based on a difference between the first quantity and the second quantity for enabling movement of the second quantity of the material during the second period.

12. The system as claimed in claim 11 including one or more sensing devices to detect a weight of the material moved during the first period, wherein the first quantity is determined based on the weight of the material.

13. The system as claimed in claim 11, wherein the first data includes at least one of a stock value or a commodity rate associated with the material being moved by the one or more machines.

14. The system as claimed in claim 11, wherein the processor is configured to:
estimate an increase in the number of the one or more machines if the second quantity is higher than the first quantity by a first value; and
estimate a decrease in the number of the one or more machines if the second quantity is lesser than the first quantity by a second value.

15. The system as claimed in claim 11, wherein the processor is configured to:
determine one or more parameters associated with an operation of the one or more machines for moving the material;
detect a deviation of the one or more parameters to an outside of a parameter threshold range; and
generate a notification based on the deviation.

16. The system as claimed in claim 15, wherein the processor is configured to:
detect a return of the one or more parameters into the parameter threshold range pursuant to the generation of the notification, wherein
the first quantity of the material is determined upon the return of the one or more parameters into the parameter threshold range.

17. The system as claimed in claim 15, wherein the one or more parameters include a quantity of fuel consumed by the one or more machines during one operational cycle at the worksite, and the parameter threshold range includes a fuel consumption threshold range determined based on a least quantity of fuel consumed by the one or more machines during a similar operational cycle at the worksite.

18. The system as claimed in claim 15, wherein the one or more parameters include a duration taken by the one or more machines to complete one operational cycle at the worksite, and the parameter threshold range includes a duration threshold range determined based on a least duration taken by the one or more machines to complete a similar operational cycle at the worksite.

19. The system as claimed in claim 15, wherein the one or more parameters include a distance travelled by the one or more machines to complete one operational cycle at the worksite, and the parameter threshold range includes a distance threshold range determined based on a least distance taken by the one or more machines to complete a similar operational cycle at the worksite.

20. The system as claimed in claim 15, wherein the one or more parameters include a payload transferred by the one or more machines during one operational cycle at the worksite, and the parameter threshold range includes a payload threshold range determined based on a maximum quantity of payload transferrable by the one or more machines for a similar operational cycle at the worksite.
